(19) United States
(12) Patent Application Publication
(10) Pub. No.: US 2022/0030874 A1
(43) Pub. Date: Feb. 3, 2022

(54) WIDE SPECTRUM MICROBICIDAL AND MICROBIOSTATIC NANOPRODUCTS AND FORMULATIONS, PREPARATIONS, AND METHODS FOR THE USE THEREOF

(71) Applicant: NanoTech Innovations Corporation, McAllen, TX (US)

(72) Inventors: VICTOR MANUEL CASTAÑO MENESES, Querétaro (MX); FELIPE ESTEVAN SAMARIO NIÑO, Ciudad de México (MX)

(73) Assignee: NanoTech Innovations Corporation, McAllen, TX (US)

(21) Appl. No.: 17/073,380

(22) Filed: Oct. 18, 2020

Related U.S. Application Data
(60) Provisional application No. 63/057,789, filed on Jul. 28, 2020.

(51) Int. Cl. A01N 59/16; A01N 59/00; A01N 25/16; C09D 5/14; A01N 59/20

(52) U.S. Cl. CPC A01N 59/16; A01N 59/00; A01N 59/20; C09D 5/14; A01N 25/16

(57) ABSTRACT

Provided herein are wide spectrum microbicidal and microbiostatic nanoproducts, and formulations and preparations of wide spectrum microbicidal and microbiostatic nanoproducts, that comprise a mono or multicomponent nanostructure having microbicidal and microbiostatic properties. Also provided are methods for the use of wide spectrum microbicidal and microbiostatic nanoproducts, as well as formulations and preparations thereof, in a variety of applications such as, for example, disinfection processes.

### CROSS-REFERENCE TO RELATED APPLICATIONS

This U.S. Non-provisional patent application was filed on Oct. 18, 2020 and claims the benefit of U.S. Provisional Patent Application No. 63/057,789, which was filed on Aug. 7, 2020 and is incorporated by reference in its entirety herein.

### BACKGROUND OF THE DISCLOSURE

### Technical Field

The present disclosure relates, in general, to the field of nanotechnology. Disclosed herein are wide spectrum nanoproducts, and formulations and preparations of wide spectrum microbicidal and microbiostatic nanoproducts, that make use of mono and multicomponent nanostructures having microbicidal and microbiostatic properties. Also disclosed are methods for the use of wide spectrum nanoproducts in a variety of applications such as, for example, disinfection processes.

### Description of the Related Art

Exposure to pathogenic microorganisms (including pathogenic bacteria, pathogenic fungi, and pathogenic viruses) has been a constant danger to the population through the years, causing outbreaks of diseases and pandemics that affect millions of persons. Ghiglione et al., Environ. Sci. Pollut. Res. 23:3981-3983 (2016). This issue is considered an emerging focus of public health care, both in developed and developing countries. These outbreaks are caused by various factors such as inefficient hygienic practices, infections caused by crowds of people, vector transmission, and other environmental causes. World Health Organization, Prevention of hospital-acquired infections: a practical guide WHO/CDS/CSR/EPH/2002.12 Geneva, Switzerland: World Health Organization (2002). In recent years, the spread and resistance of pathogenic microorganisms (collectively, “pathogens”) to common antimicrobial agents has caused serious health and food problems worldwide.

For centuries, metals such as silver have been used in surgical utensils to treat burns and chronic wounds, while copper has been used to make water drinkable. Song & Jang, Advances in Colloid and Interface Science 203:37-50 (2014) and Tamayo et al., Materials Science and Engineering C 40:24-31 (2014). Recently, special emphasis has been given to the study of nanoparticles, given that their inherent antimicrobial activity prevents the microorganism from generating resistance through microbiostatic and microbicidal processes. Monteiro et al., International Journal of Antimicrobial Agents 34(2):103-110 (2009).

Different studies have reported that metallic and oxide-metallic nanoparticles are considered as a group of materials that can be studied due to their antimicrobial properties. Dutta et al., Colloids and Surfaces B: Biointerfaces 94:143-150 (2012) and Salem et al., International Journal of Medical Microbiology 305:85-95 (2015).

A variety of compositions that occupy different nanoparticles have been described for the disinfection process. For example, RU2698713(C1) discloses a method for obtaining a composite material with antimicrobial properties, delimiting its protection to the use of graphene oxide and copper oxide nanoparticles. This patent application focuses its application to the field of nanobiotechnologies and nanomedicine, to make preparations that suppress the vital activity of pathogenic microorganisms.

WO2019074386A1 discloses a method and composition of washable biocidal paint, with properties for disinfecting interior surfaces. Its composition is based on aqueous acrylic-styrene resins, in which a photosensitive biocidal agent was dispersed, specifically TiO₂ or ZnO particles, which were doped with transition metals such as Au, Cu, Ni, Ag, Fe, Cr, Co, Mn. Their results show a logarithmic reduction of the CFU/ml values in more than 2 units, in samples exposed to a light spectrum between 450 nm-500 nm. The antimicrobial, antifungal protection and disinfection of interior surfaces described in publication '386 delimits the application of this product in medical offices, hospitals, schools and the food industry.

The use of typical particles in disinfection processes such as TiO₂ and Ag is addressed by patent application MX2011013864A, which discloses a method for the application of ceramic enamels with antibacterial and antimicrobial properties based on rutile phase titanium dioxide fine particles and silver nanoparticles on ceramic products. This application identifies methods that are particularly appropriate in the manufacture of ceramic tile coatings for floors, tiles and sanitary furniture on which effective and durable antibacterial and antimicrobial properties will be obtained.

The disinfection processes in antibacterial films were reported in CN108795289 based on the use of Si, Cu and TiO₂. The inventors mention that the method uses a titanium plate as the substrate, which has a high antibacterial property and is claimed not to be susceptible to bacterial infection, thereby improving the success rate and increasing wear resistance.

PCT Patent Publication No. WO2011033040A2 discloses a method for the synthesis of ZnO antibacterial nanoparticles based on copper or magnesium doped, and its antibacterial activity is evaluated on Escherichia coli (E. coli) and Staphylococcus carnosus (S. carnosus). The patent application focuses on the protection in the synthesis of ZnO particles by means of a wet process in methanol as the reaction medium, and during the synthesis, the ZnO particles are doped with various amounts of copper or magnesium. This patent application shows that Cu and Mg-doped nanoparticles have antibacterial activity, however, it is highly dependent on the concentration of ZnO nanoparticles.

There remains a need in the art for compositions exhibiting improved, wide spectrum microbicidal and microbiostatic properties.

### SUMMARY OF THE DISCLOSURE

The present disclosure remedies a need in the art for improved compositions having advantages over other reported systems/substances including: (1) wider spectrum of bacteria destroyed and/or inactivated, (2) destroys viruses generally, including the human coronavirus and related viruses, (3) higher retention on surfaces, (4) attacks both gram positive and gram negative microorganisms, (5) kills fungi, (6) destroys mold, and (7) exhibits bacteriostatic properties

The compositions disclosed herein include the use of a) a glycol, an organic solvent or a polymeric resin as a vehicle; b) mono and multicomponent nanostructures selected from one or more inorganic nanoparticles, one or more ceramic nanoparticles and one or more carbonaceous nanoparticles; c) a rheology modifier, and d) a surfactant.

In one embodiment, the use of a glycol, an oxygenated organic solvent, a water-based acrylic resin; any of them present in a range of between 10 and 90% by weight.

The invention can be characterized by the use of selected mono and multicomponent nanostructures of one or more inorganic nanoparticles, one or more ceramic nanoparticles described in the compositions of this nanoproduct, which can be selected from the group of metal oxides, transition metals, functionalized nanoparticles of zinc oxide, and one or more carbonaceous nanoparticles and mixtures thereof.

In certain cases carbonaceous nanoparticles can be chosen from the group comprising fullerenes, diamond, single-walled carbon nanotubes, multiple-walled carbon nanotubes, graphene nanoplates, graphene oxide, and reduced graphene as well as mixtures of them.

In certain aspects of the invention, the total of the nanoparticles can comprise from about 0.05% to 10% of the total weight of the composition and their size can be from 1 to 100 nm.

### DETAILED DESCRIPTION

The present disclosure provides nanoproduct compositions that have microbicidal and microbiostatic properties, using mono and multicomponent nanostructures, selected from one or more inorganic nanoparticles, one or more ceramic nanoparticles and one or more carbonaceous nanoparticles.

An embodiment of the invention includes the use of compositions such as a) a glycol, an oxygenated organic solvent or a polymeric resin as a vehicle b) multicomponent nanostructures selected from one or more inorganic nanoparticles and one or more ceramic nanoparticles, including titania, silica, ceria, zinc oxide and combinations and alloys of them, as well as core-shell structures of these nanoparticles, c) a rheology modifier and d) a surfactant.

In one embodiment, the use of a glycol selected from butyl glycol, butyldiglycol, diethylene glycol, ethylene glycol, polyethylene glycol, and propylene glycol or the use of an oxygenated organic solvent selected from the group consisting of alcohols, ketones, esters, ethers, glycol ethers, and ether esters glycol or the use of a water-based acrylic resin selected from diphenylmethane diisocyanate or toluene diisocyanate; any of them present in a range of between 10 and 90% by weight.

In one embodiment of the invention, selected mono and multicomponent nanostructures of one or more inorganic nanoparticles and one or more ceramic nanoparticles can include zinc oxide nanoparticles (ZnO), tin dioxide nanoparticles (SnO₂), titanium dioxide nanoparticles (TiO₂), silicon dioxide (SiO₂) nanoparticles, silver (Ag) nanoparticles, gold (Au) nanoparticles, cobalt (Co) nanoparticles, chromium (Cr) nanoparticles, copper (Cu) nanoparticles, iron (Fe), nickel (Ni) nanoparticles, manganese (Mn) nanoparticles, zinc (Zn) nanoparticles, carbonaceous nanoparticles and mixtures thereof. The size of these nanoparticles ranges from 1 to 100 nm and can be present in a proportion of 0.05% to 10% by weight. In certain respects, carbonaceous nanoparticles can be chosen from the group comprising fullerenes, diamond, single-walled carbon nanotubes, multiple-walled carbon nanotubes, graphene nanoplates, graphene oxide, and reduced graphene. In an embodiment of the invention, the use of additives such as a rheology modifier for aqueous systems, and/or a polymeric catalyst with low levels of volatile organic compounds, can be present in a proportion between 1 and 10% by weight depending on glycol or selected resin.

According to one preferred embodiment of the invention multicomponent nanostructures comprise a mixture of metallic and ceramic nanoparticles. A typical composition is: 0.09% wt Ag, 0.12% wt ZnO, 0.11% wt TiO2. The ratio of the different nanoparticles is also important for the effectiveness of the formulation. The ratios are as follows: 1 to 1.25 Ag/0.85 to 1.9 ZnO/1.01 to 1.85 TiO2.

According to another preferred embodiment the multicomponent nanostructures comprise one metallic nanoparticle, such as silver (Ag) nanoparticle and at least one ceramic nanoparticle, such as zinc oxide nanoparticles (ZnO), titanium dioxide nanoparticles (TiO2), wherein the metallic and ceramic nanoparticles form a core-shell structure or other nanoscale shape.

Exemplary suitable additives that may be employed in the nanoproduct compositions disclosed herein may include: a surfactant selected from the group consisting of a derivative of a carboxylic acid, a derivative of a sulfuric acid, a derivative of a sulfonic acid, and a derivative of a phosphoric acid and wherein the surfactant is at a concentration of from 1% by weight to 5% by weight; a rheology modifier preferably a nonionic rheology modifier for aqueous systems and wherein the nonionic rheology modifier is at a concentration of from 0.1% by weight to 2% by weight.

Table 1 discloses the results of several laboratory tests that were performed with an exemplary nanoproduct according to the present disclosure.

TABLE 1
Laboratory Tests with an Exemplary Nanoproduct

| | | PERFORMED | |
|---|---|---|---|
| TEST | APPLIED NORM | BY | RESULT |
| Evaluation of | ASTM D 5590 | EBYSOS | The product prevents 99.9% of |
| microbiological | | | growth of microorganisms |
| resistance to test | | | |
| material | | | |
| Evaluation of | ISO 22196: 2007 | NYCE | No bacteria-forming units were |
| microbiological | | | detected in the samples analyzed |
| resistance after 336 | | | |
| hours of accelerated | | | |
| aging | | | |
| Dermic irritation | F.E.U.M 12a edición | EBYSOS | No erythema or edema were |
| | | | observed neither on intact skin or |
| | | | damaged skin, under exposure up to |
| | | | 72 h. |
| Dermic irritation on | F.E.U.M. 12^{a} edición | EBYSOS | No erythema or edema were |
| eroded skin | | | observed neither on damaged skin, |
| | | | under exposure up to 72 h. |
| In vitro ocular | Modelo Epi-ocular | EBYSOS | No irritability in exposure higher |
| irritation | | | than 24 h |
| pH | ASTM E 70 | EBYSOS | Product fulfils norm |

The nanoproduct according to the present disclosure eliminates and inhibits the following microorganisms: Gram Positive bacteria such as: Streptococcus pyogenes, Enterococcus faecalis, Staphylococcus aureus, Bacillus cereus, Bacillus mycoides; Brevibacterium ammoniagenes, Corynebacterium pseudodiphtheriticum, Micrococcus luteus, Bacillus subtilis, Enterobacter faecalis; gram negative bacteria, such as: Klebsiella pneumoniae, Pseudomonas aeruginosa, Proteus vulgaris, Salmonella typhimurium, Acinetobacter calcoaceticus, Providencia rettgeri, Enterobacter aerogenes, Escherichia coli; fungi, such as: Alternaria dianthicola, Aspergillus niger, Aspergillus oryzae, Aspergillus repens, Candida albicans, Chaetomium globosum; and viruses, such as: Hepatitis B, Hepatitis C, VIH, Ebolavirus, Human Coronavirus (SARS-COV).

While various embodiments have been disclosed herein, other embodiments will be apparent to those skilled in the art. The various embodiments disclosed herein are for purposes of illustration and are not intended to be limiting, with the true scope and spirit being indicated by the claims. All references cited herein, whether supra or infra, are incorporated by reference in their entirety.

### EXAMPLES

The present disclosure is further described with reference to the following examples, which are provided to illustrate certain embodiments and are not intended to limit the scope of the present disclosure or the subject matter claimed.

### Example 1

### Microbicidal and Microbiostatic Nanoproduct Coating Formulations

Tables 2A-2D disclose illustrative microbicidal and microbiostatic nanoproduct coating formulations according to certain embodiments as described herein.

TABLE 2A
Microbicidal and Microbiostatic Nanoproduct Coating
Formulations with Multicomponent Nanostructures
Comprising Ceramic Oxide Nanoparticles

| | CONCENTRATION |
|---|---|
| COMPONENT | (WEIGHT %) |
| Glycol | 30-50% |
| Water | 30-50% |
| Multicomponent nanostructures | 0.1-2% |
| comprising ceramic oxide nanoparticles | |
| (e.g. titania, silica, ceria, zinc oxide and | |
| combinations and alloys of them, as well as | |
| core-shell structures of these nanoparticles) | |
| Amphoteric surfactant | 0.1-5% |
| Rheology modifier | 0.1-5% |

TABLE 2B
Microbicidal and Microbiostatic Nanoproduct Coating
Formulations with Multicomponent Nanostructures
Comprising Inert Metallic Nanoparticles

| | CONCENTRATION |
|---|---|
| COMPONENT | (WEIGHT %) |
| Glycol | 30-50% |
| Water | 30-50% |
| Multicomponent nanostructures | 0.1-2% |
| comprising inert metallic nanoparticles | |
| (e.g., zinc oxide (ZnO), tin dioxide (SnO₂), | |
| titanium dioxide (TiO₂), silicon dioxide | |
| (SiO₂), silver (Ag), gold (Au), cobalt (Co), | |
| chromium (Cr), copper (Cu), iron (Fe), | |
| nickel (Ni), manganese (Mn), zinc (Zn) | |
| nanoparticles) | |
| Amphoteric surfactant | 0.1-5% |
| Rheology modifier | 0.1-5% |

TABLE 2C
Microbicidal and Microbiostatic Nanoproduct Coating
Formulations with Multicomponent Nanostructures
Comprising Carbonaceous Nanoparticles

| | CONCENTRATION |
|---|---|
| COMPONENT | (WEIGHT %) |
| Glycol | 30-50% |
| Water | 30-50% |
| Multicomponent nanostructures | 0.1-2% |
| comprising carbonaceous nanoparticles | |
| (e.g., nanotubes, fullerenes, and graphene | |
| nanoparticles) | |
| Amphoteric surfactant | 0.1-5% |
| Rheology modifier | 0.1-5% |

TABLE 2D
Microbicidal and Microbiostatic Nanoproduct Coating Formulations
with Multicomponent Nanostructures Comprising a Mixure
of Ceramic Oxide Nanoparticles, Inert Metallic Nanoparticles
and/or Carbonaceous Nanoparticles

| | CONCENTRATION |
|---|---|
| COMPONENT | (WEIGHT %) |
| Glycol | 30-50% |
| Water | 30-50% |
| Multicomponent nanostructures | 0.1-6% |
| comprising a mixure of ceramic oxide | |
| nanoparticles; inert metallic nanoparticles | |
| and/or carbonaceous nanoparticles; alloys | |
| of them, as well as core-shell structures of | |
| these nanoparticles | |
| Amphoteric surfactant | 0.1-5% |
| Rheology modifier | 0.1-5% |

### Example 2

### Microbicidal and Microbiostatic Nanoproducts in Foam Formulations

Tables 3A-3D disclose illustrative microbicidal and microbiostatic nanoproduct foam formulations according to certain embodiments as described herein.

TABLE 3A
Microbicidal and Microbiostatic Nanoproduct Foam
Formulations with Multicomponent Nanostructures
Comprising Ceramic Oxide Nanoparticles

| | CONCENTRATION |
|---|---|
| COMPONENT | (WEIGHT %) |
| Water | 30-50% |
| Oxygenated organic solvent | 30-50% |
| Amphoteric surfactant | 1-5% |
| Multicomponent nanostructures | 0.1-2% |
| comprising ceramic oxide nanoparticles | |
| (e.g., titania, silica, ceria, zinc oxide and | |
| combinations and alloys of them, as well as | |
| core-shell structures of these nanoparticles) | |

TABLE 3B
Microbicidal and Microbiostatic Nanoproduct Foam
Formulations with Multicomponent Nanostructures
Comprising Inert Metallic Nanoparticles

| | CONCENTRATION |
|---|---|
| COMPONENT | (WEIGHT %) |
| Water | 30-50% |
| Oxygenated organic solvent | 30-50% |
| Amphoteric surfactant | 1-5% |
| Multicomponent nanostructures | 0.1-2% |
| comprising inert metallic nanoparticles | |
| (e.g., zinc oxide (ZnO), tin dioxide (SnO₂), | |
| titanium dioxide (TiO₂), silicon dioxide | |
| (SiO₂), silver (Ag), gold (Au), cobalt (Co), | |
| chromium (Cr), copper (Cu), iron (Fe), | |
| nickel (Ni), manganese (Mn), zinc (Zn) | |
| nanoparticles) | |

TABLE 3C
Microbicidal and Microbiostatic Nanoproduct Foam
Formulations with Multicomponent Nanostructures
Comprising Carbonaceous Nanoparticles

| | CONCENTRATION |
|---|---|
| COMPONENT | (WEIGHT %) |
| Water | 30-50% |
| Oxygenated organic solvent | 30-50% |
| Amphoteric surfactant | 1-5% |
| Multicomponent nanostructures | 0.1-2% |
| comprising carbonaceous nanoparticles | |
| (e.g., nanotubes, fullerenes, and graphene | |
| nanoparticles) | |

TABLE 3D
Microbicidal and Microbiostatic Nanoproduct Foam Formulations
with Multicomponent Nanostructures Comprising a Mixure
of Ceramic Oxide Nanoparticles, Inert Metallic Nanoparticles
and/or Carbonaceous Nanoparticles

| | CONCENTRATION |
|---|---|
| COMPONENT | (WEIGHT %) |
| Water | 30-50% |
| Oxygenated organic solvent | 30-50% |
| Amphoteric surfactant | 1-5% |
| Multicomponent nanostructures | 0.1-6% |
| comprising mixure of ceramic oxide | |
| nanoparticles; inert metallic nanoparticles | |
| and/or carbonaceous nanoparticles; alloys | |
| of them, as well as core-shell structures of | |
| these nanoparticles | |

### Example 3

### Microbicidal and Microbiostatic Nanoproducts in Liquid Formulations

Tables 4A-4D disclose illustrative microbicidal and microbiostatic nanoproduct liquid formulations according to certain embodiments as described herein.

TABLE 4A
Microbicidal and Microbiostatic Nanoproduct Liquid
Formulations with Multicomponent Nanostructures
Comprising Ceramic Oxide Nanoparticles

| | CONCENTRATION |
|---|---|
| COMPONENT | (WEIGHT %) |
| Water | 30-50% |
| Oxygenated organic solvent | 30-50% |
| Multicomponent nanostructures | 0.1-2% |
| comprising ceramic oxide nanoparticles | |
| (e.g., titania, silica, ceria, zinc oxide and | |
| combinations and alloys of them, as well as | |
| core-shell structures of these nanoparticles) | |

TABLE 4B
Microbicidal and Microbiostatic Nanoproduct Liquid
Formulations with Multicomponent Nanostructures
Comprising Inert Metallic Nanoparticles

| | CONCENTRATION |
|---|---|
| COMPONENT | (WEIGHT %) |
| Water | 30-50% |
| Oxygenated organic solvent | 30-50% |
| Multicomponent nanostructures | 0.1-2% |
| comprising inert metallic nanoparticles | |
| (e.g., zinc oxide (ZnO), tin dioxide (SnO₂), | |
| titanium dioxide (TiO₂), silicon dioxide | |
| (SiO₂), silver (Ag), gold (Au), cobalt (Co), | |
| chromium (Cr), copper (Cu), iron (Fe), | |
| nickel (Ni), manganese (Mn), zinc (Zn) | |
| nanoparticles) | |

TABLE 4C
Microbicidal and Microbiostatic Nanoproduct Liquid
Formulations with Multicomponent Nanostructures
Comprising Carbonaceous Nanoparticles

| | CONCENTRATION |
|---|---|
| COMPONENT | (WEIGHT %) |
| Water | 30-50% |
| Oxygenated organic solvent | 30-50% |
| Multicomponent nanostructures | 0.1-2% |
| comprising carbonaceous nanoparticles | |
| (e.g., nanotubes, fullerenes, and graphene | |
| nanoparticles) | |

TABLE 4D
Microbicidal and Microbiostatic Nanoproduct Liquid Formulations
with Multicomponent Nanostructures Comprising Mixure
of Ceramic Oxide Nanoparticles, Inert Metallic Nanoparticles
and/or Carbonaceous Nanoparticles

| | CONCENTRATION |
|---|---|
| COMPONENT | (WEIGHT %) |
| Water | 30-50% |
| Oxygenated organic solvent | 30-50% |
| Multicomponent nanostructures | 0.1-6% |
| comprising mixure of ceramic oxide | |
| nanoparticles; inert metallic nanoparticles | |
| and/or carbonaceous nanoparticles; alloys | |
| of them, as well as core-shell structures of | |
| these nanoparticles | |

The foregoing description is intended to illustrate and not limit the scope of the present disclosure. Other aspects, advantages and modifications are within the scope of the following claims.

What is claimed is:

1. A microbicidal and microbiostatic nanoproduct comprising
a) a vehicle that is selected from the group consisting of a glycol, an oxygenated organic oxygen, and a polymeric resin;
b) a mono or multicomponent nanostructure that is selected from the group consisting of inorganic nanoparticles, ceramic nanoparticles, carbonaceous nanoparticles;
and combinations, alloys of them, and core-shell structures of these nanoparticles;
c) a rheology modifier; and
d) a surfactant.

2. The microbicidal and microbiostatic nanoproduct of claim 1 wherein the vehicle is a glycol that is selected from the group consisting of butyl glycol, butyl diglycol, diethylene glycol, ethylene glycol, polyethylene glycol, and propylene glycol.

3. The microbicidal and microbiostatic nanoproduct of claim 1 wherein the vehicle is an oxygenated organic oxygen that is selected from the group consisting of an alcohol, a ketone, an ester, an ether, a glycol ether, and a glycol ether ester.

4. The microbicidal and microbiostatic nanoproduct of claim 1 wherein the vehicle is a polymeric resin that is a water-based acrylic resin selected from the group consisting of diphenylmethane diisocyanate and toluene diisocyanate.

5. The microbicidal and microbiostatic nanoproduct of claim 1
wherein the vehicle is affected by the presentation of the final product and
wherein the vehicle is at a concentration of from 10% by weight to 90% by weight.

6. The microbicidal and microbiostatic nanoproduct of claim 1
wherein the mono or multicomponent nanostructure has a particle size of from 1 nm to 100 nm and
wherein the mono or multicomponent nanostructure is microbicidal and microbiostatic.

7. The microbicidal and microbiostatic nanoproduct of claim 1 wherein the mono or multicomponent nanostructure comprises a nanoparticle that is selected from the group consisting of a tin dioxide nanoparticle (SnO₂), a titanium dioxide (TiO₂) nanoparticle, a silicon dioxide (SiO₂) nanoparticle, a silver (Ag) nanoparticle, a gold (Au) nanoparticle, a cobalt (Co) nanoparticle, a chromium (Cr) nanoparticle, a copper (Cu) nanoparticle, an iron (Fe) nanoparticle, a nickel (Ni) nanoparticle, a manganese (Mn) nanoparticle, a zinc (Zn) nanoparticle, and a carbonaceous nanoparticle.

8. The microbicidal and microbiostatic nanoproduct of claim 7 wherein the nanoparticle is a carbonaceous nanoparticle that is selected from the group consisting of a fullerene, a diamond, a single-walled carbon nanotube, a multiple-walled carbon nanotube, a graphene nanoplate, a graphene oxide, and a reduced graphene.

9. The microbicidal and microbiostatic nanoproduct of claim 1
wherein the rheology modifier is a nonionic rheology modifier for aqueous systems and
wherein the nonionic rheology modifier is at a concentration of from 0.1% by weight to 2% by weight.

10. The microbicidal and microbiostatic nanoproduct of claim 1
wherein the surfactant is selected from the group consisting of a derivative of a carboxylic acid, a derivative of a sulfuric acid, a derivative of a sulfonic acid, and a derivative of a phosphoric acid and
wherein the surfactant is at a concentration of from 1% by weight to 5% by weight.

11. A microbicidal and microbiostatic nanoproduct formulation comprising a microbicidal and microbiostatic nanoproduct of claim 1
wherein the formulation is selected from the group consisting of a coating formulation, a foam formulation, and a liquid formulation.

12. The microbicidal and microbiostatic nanoproduct formulation of claim 11
wherein the formulation is a foam formulation that comprises a propellant that is selected from the group consisting of dimethyl ether, isobutane, carbon dioxide, nitrous oxide, nitrogen, compressed air, and propane and
wherein the propellant is at a concentration of from 5% by weight and 25% by weight.

13. The microbicidal and microbiostatic nanoproduct formulation of claim 11
wherein the formulation is a liquid formulation that is suitable for delivery via aspiration, nebulization, atomization, and direct application.

14. The microbicidal and microbiostatic nanoproduct formulation of claim 11
wherein the formulation is a coating formulation that is selected from the group consisting of a film formulation, a lacquer formulation, and a paint formulation.
